(19) United States
(12) Patent Application Publication
(10) Pub. No.: US 2024/0407516 A1
(43) Pub. Date: Dec. 12, 2024

(54) PROTECTIVE CASE ROTATING SHAFT

(71) Applicant: Shenzhen Trusted Huacheng Communication Technology Co., Ltd., Shenzhen (CN)

(72) Inventor: KE JIANG, Shenzhen (CN)

(21) Appl. No.: 17/771,803

(22) PCT Filed: Apr. 2, 2022
(86) PCT No.: PCT/CN22/85035

§ 371 Date: Apr. 25, 2022

(30) Foreign Application Priority Data
Jan. 12, 2022 (CN) 202210031283.0

(51) Int. Cl. A45C 13/00; A45C 11/00; F16C 11/04; G06F 1/16

(52) U.S. Cl. CPC A45C 13/005; A45C 11/00; F16C 11/04; G06F 1/1628; A45C 2011/003

(57) ABSTRACT

A protective case rotating shaft comprises a main rotating flap mechanism and auxiliary rotating flap mechanisms arranged at both sides of the main rotating mechanism. The auxiliary rotating flap mechanism is connected to the main rotating flap mechanism through a connecting piece, which is configured to movably connect the main rotating flap mechanism with the auxiliary rotating flap mechanism together, so that the main and the auxiliary rotating flap mechanism move around the connecting piece at fixed points to form an opening angle, and the opening angle is 0-80 degrees. The features of the application are that it is easy to assemble, has a wide range of use, has various functions, is strong and durable, and can act as a mobile bracket for electronic equipment; at the same time, it can control the protective clip at 0 degrees and 30 degrees, 45 degrees or 60 degrees to open and close.

### CROSS-REFERENCE TO RELATED APPLICATIONS

This is a continuation of International Application PCT/CN2022/085035, with an international filing date of Apr. 2, 2022, which claims foreign priority of Chinese Patent Application No. 202210031283.0, filed on Jan. 12, 2022 in the State Intellectual Property Office of China, the contents of all of which are hereby incorporated by reference.

### TECHNICAL FIELD

The present application relates to the technical field of protective case accessories, in particular to a rotating shaft applied to a protective sleeve or a protective case of a portable mobile terminal, such as a rotating shaft applied to a tablet computer or a keyboard protective case, in particular a protective case rotating shaft.

### BACKGROUND

When the mobile terminal device is in use, a protective cover or protective case is usually added to the terminal device to protect the terminal device and prolong the service life of the terminal device. When designing a protective cover or protective case, two axially connected rubber plates are usually used to protect the top surface and bottom surface of the mobile terminal respectively. Generally speaking, after the rubber plate is opened and closed for a period of time, the hinge of the sleeve or protective case will be severely damaged and broken, so the two rubber plates will be separated, which will affect the use of the protective case of the terminal equipment. At the same time, the protective cover or protective shell combined with the hinge rubber plate has a single function, and can only be used as a movable part to combine the two components. The protective case is damaged due to excessive expansion, the hinges are broken, and the overall durability of the protective case or protective cover is poor.

### SUMMARY

The purpose of the present application is to provide a protective case rotating shaft to solve the above-mentioned problems in the background art.

To achieve the above purpose, the application provides the following technical solutions: A protective case rotating shaft, comprising a main rotating flap mechanism and auxiliary rotating flap mechanisms arranged at both sides of the main rotating flap mechanism, the auxiliary rotating flap mechanism is configured to connect with the main rotating flap mechanism through a connecting piece, and the main rotating flap mechanism is composed of a rotating shaft connecting seat and a main connecting part connected to the rotating shaft connecting seat, the auxiliary rotating flap mechanism is composed of a rotating pillar and an auxiliary connecting part connected to the rotating pillar, the connecting piece is configured to connect the main rotating flap mechanism with the auxiliary rotating flap mechanism together, so that the main rotating flap and the auxiliary rotating flap mechanism move around the connecting piece at fixed points to form an opening angle, and the opening angle is 0-80 degrees, the connecting piece is configured to be a rotating head with two parts: an inner end and an outer end, the inner end is configured to be inserted into a main mounting hole at the end of the rotating shaft connecting seat, and the outer end is configured to be inserted into an auxiliary mounting hole at the end of the rotating pillar.

Further, the rotating head is configured to pivot the main rotating flap mechanism and the auxiliary rotating flap mechanism into one piece and the lateral length of the outer end of the rotating head does not exceed the lateral length of the inner end.

Further, the inner end is a left post extending into the main mounting hole, a platform is arranged in the cavity of the main mounting hole, and the outer surface of the inner end is provided with concave-convex parts; the concave-convex parts are configured to increase the connection stability between the rotating head and the rotating shaft connecting seat, and the concave-convex parts comprise convex parts connected to the left post and concave parts arranged on the outer wall of the convex parts.

Further, the cross-sectional shape of the platform is configured to be the shape of a ring, the platform is provided with a circular hole into which the left post extends, and the platform is configured to support the convex part, and the convex part is closely attached to the hole wall of the main mounting hole.

Further, the convex part comprises a fixed wheel and a positioning ring that are sequentially fixed and sleeved on the left post, the fixed wheel is located at the end of the left post, and the diameter of the wheel body of the fixed wheel is equal to the inner hole diameter of the main mounting hole, and the fixed wheel is configured to limit the opening angle between the main rotating flap mechanism and the auxiliary rotating flap mechanism to 0 degrees or 20-70 degrees, the concave part comprises a notch provided on the side wall of the fixed wheel and a groove opened on the side wall of the fixed wheel, and at least two grooves are provided.

Further, tooth-like patterns for increasing the surface roughness are distributed on the outer wall of the fixed wheel and the left post at intervals, and the tooth-like patterns on the left post is closely attached to the hole wall of the circular hole inside the platform.

Further, the outer end is configured to be a right insertion post inserted into the auxiliary mounting hole, and the right insertion post is inserted into the auxiliary mounting hole.

Further, a boss is integrally connected to the end of the right insertion post, and a concave position for the boss to be inserted is provided in the auxiliary mounting hole.

Further, the main connecting part and the auxiliary connecting part are both provided with through holes, and the auxiliary connecting part is vertically connected on a central axis of the outer wall of the rotating pillar, and the main connecting portion is vertically connected on a central axis of the outer wall of the rotating shaft connecting seat.

Further, the lateral length of the rotating pillar does not exceed the lateral length of the rotating shaft connecting seat, and the outer surfaces of the ends of the rotating pillar and the rotating shaft connecting seat are both provided with a frosted layer.

The beneficial effects of this application are:

The application is easy to assemble, has a wide range of use, and has various functions. It can be applied to the movable connection of two components on mobile terminal equipment, and It can be used in the field of mobile phone brackets, mobile terminal brackets, electronic equipment protective sleeves, tablet protective sleeves. At the same time, the protective case can be controlled to be unfolded and closed between four positions of 0 degrees, 30 degrees, 45 degrees or 60 degrees, so that the protective case will not be squeezed and worn on the mobile terminal due to excessive clamping. The protective case will not be damaged due to excessive expansion, and the overall durability of the rotating shaft of the protective case is improved.

### BRIEF DESCRIPTION OF DRAWINGS

FIG. 1 is a structural perspective diagram of the application;

FIG. 2 is a structural exploded diagram of the application;

FIG. 3 is the structural perspective diagram of the combined state of the rotating shaft connecting seat and the main connecting plate of the application;

FIG. 4 is an enlarged schematic diagram of the partial structure at B of FIG. 3 of the application;

FIG. 5 is a perspective diagram of the structure of the application in the combined state of the first rotating pillar and the first connecting plate;

FIG. 6 is an enlarged schematic diagram of the partial structure at C of FIG. 5 of the application;

FIG. 7 is a structural perspective diagram of the first connecting piece of the present application;

FIG. 8 is a top view of the structure of FIG. 1 of the application;

FIG. 9 is a cross-sectional structural diagram across A-A line in FIG. 8 of the application;

FIG. 10 is a schematic structural diagram of the Embodiment 2 of the present application in a use state;

FIG. 11 is a schematic structural diagram of Embodiment 3 of the present application in a use state.

1. Rotating shaft connecting seat, 101. main mounting hole, 102. main supporting table, 2. main connecting plate, 3. first rotating pillar, 301. first mounting hole, 302. auxiliary supporting table, 4. first connecting plate, 5. second rotating pillar, 501. second mounting hole, 502 socket, 6 second connecting plate, 7 second connecting piece, 8 first connecting piece, 81 fixed wheel, 82 groove, 83 notch, 84 right post, 85 boss, 86 left insertion post, 87 positioning ring, 9 hole sealing plug, 10 main splint, 11 auxiliary splint.

### DETAILED DESCRIPTION

Next, the technical solutions in the present application embodiment will be described in conjunction with the drawings in the embodiments of the present application. Obviously, the described embodiments are merely the embodiments of the present invention, not all of the embodiments, the above are only the preferred embodiments of the present application, and are not intended to limit the present application. Based on the embodiments in the present application, all other embodiments obtained by those of ordinary skill in the art without making creative labor will fall into the scope of the application.

### Embodiment 1

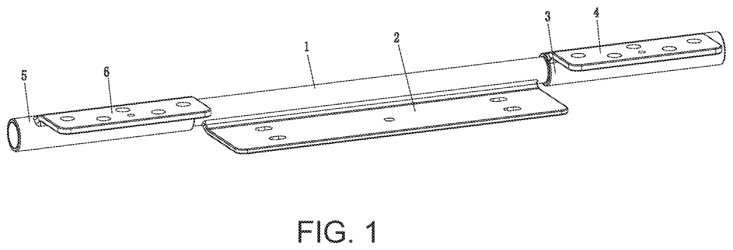

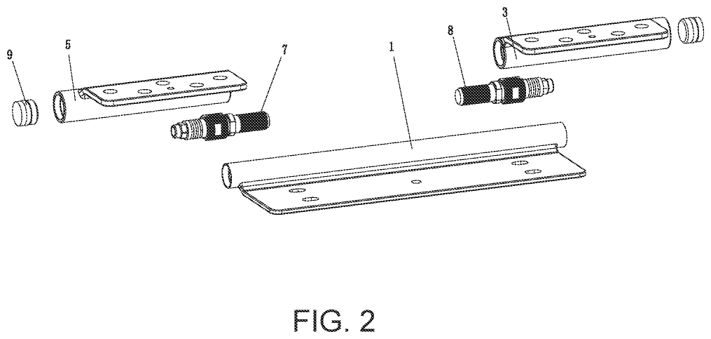

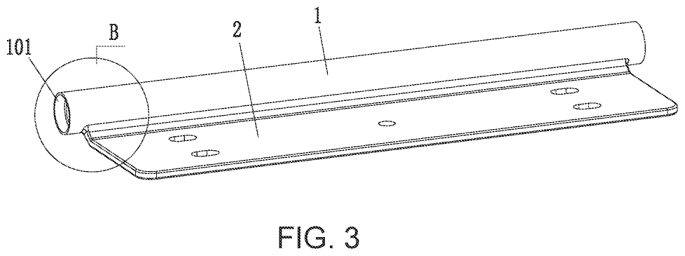

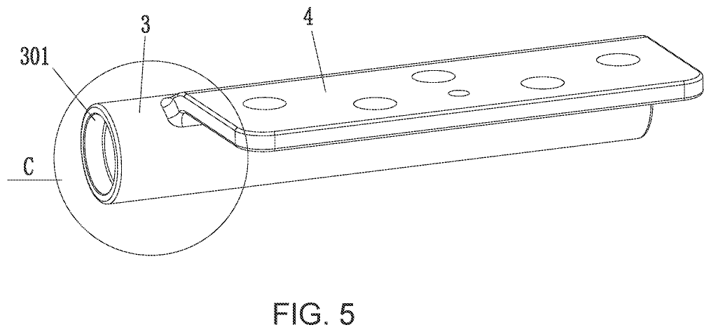

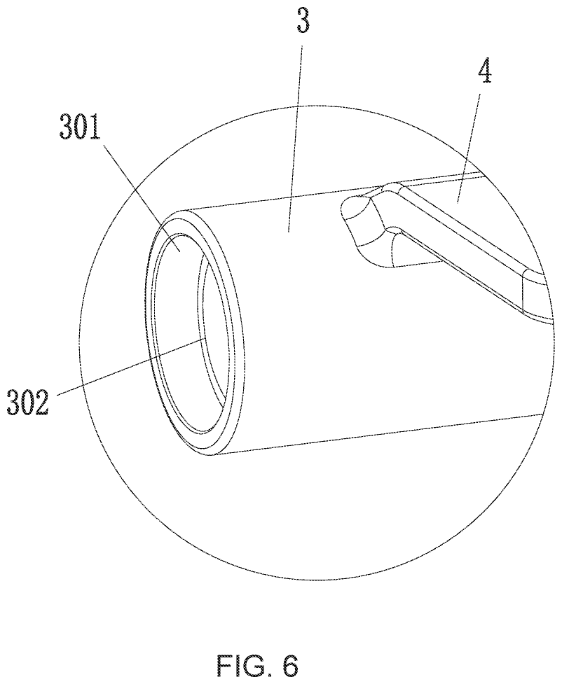

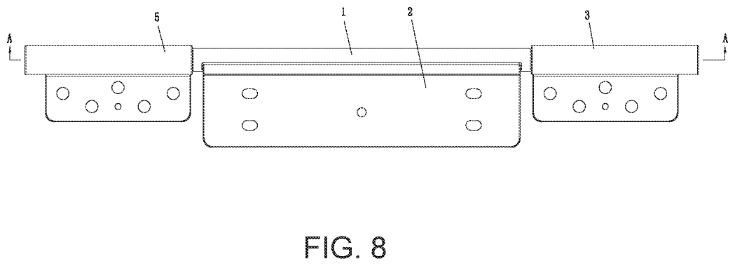

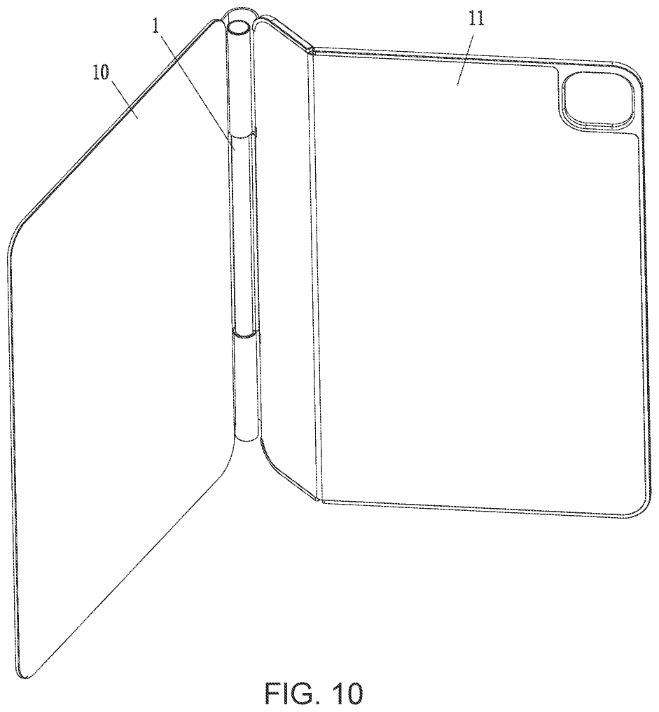

Please refer to FIGS. 1-10, which provide an embodiment of a protective case rotating shaft for the application, comprising a main rotating flap mechanism, auxiliary rotating flap mechanisms, and a connecting piece for connecting the main rotating flap mechanism with the auxiliary rotating flap mechanism together. The protective case rotating shaft is applied to the protective sleeve or protective case of the mobile terminal, and the main rotating flap mechanism is composed of a rotating shaft connecting seat 1 and a main connecting part connected to the rotating shaft connecting seat 1. The main connecting part is connected to the upper component of the mobile terminal, the main connecting part is the main connecting plate 2, and the main connecting plate 2 is connected to the main splint 10 of the protective case or protective shell of the mobile terminal. Two auxiliary rotating flap mechanisms are correspondingly connected at both ends of the rotating shaft connection base 1. The auxiliary rotating flap mechanism is composed of a rotating pillar and an auxiliary connecting part connected to the rotating pillar, and the auxiliary connecting part of the auxiliary rotating flap mechanism is connected to the auxiliary splint 11 of the protective case or the protective shell for the mobile terminal, the two auxiliary rotating flap mechanisms are the first auxiliary rotating flap mechanism and the second auxiliary rotating flap mechanism. The first auxiliary rotating flap mechanism is composed of a first rotating pillar 3 and a first connecting plate 4 connected to the first rotating pillar 3, and the second auxiliary rotating flap mechanism is composed of a second rotating pillar 5 and a second connecting plate 6 connected to the second rotating pillar 5. The rotating pillar is the first rotating pillar 3 or the second rotating pillar 5, the lateral length of the rotating pillar does not exceed the lateral length of the rotating shaft connecting seat 1, and the outer surfaces of the ends of the rotating pillar and the rotating shaft connecting seat 1 are both provided with a frosted layer The provided frosted layer can increase the roughness of the end of the rotating pillar and the rotating shaft connecting seat 1, and at the same time improve the friction force between the rotating pillar and the end of the rotating shaft connecting seat 1, so that the rotating head can more firmly connect the rotating pillar and the rotating shaft connecting seat 1. The connection is integral, that is, the connecting piece formed by the left post 86 and the right post 84 is configured to movably connect the main rotating flap mechanism and the auxiliary rotating flap mechanism into one piece.

Both the main connecting part and the auxiliary connecting part can be made of but not limited to aluminum plates, and both the main connecting part and the auxiliary connecting part are provided with through holes, and the auxiliary connecting part is vertically connected on the central axis of the outer wall of the rotating pillar and the main connecting part is vertically connected on the central axis of the outer wall of the rotating shaft connecting seat 1. The top-view shapes of the main connecting part and the auxiliary connecting part are all rectangular structures. The through holes can be easily matched with external fasteners, so that the main splint 10 and the auxiliary splint 11 of the protective case of the terminal device can be connected to the corresponding connecting plate, that is, the connecting plate is the main connecting plate 2, the first connecting plate 4 and the second connecting plate 6.

It should be noted that the connecting piece is configured to movably connect the main rotating flap mechanism and the auxiliary rotating flap mechanism into one piece, so that the main rotating flap mechanism and the auxiliary rotating flap mechanism move around the connecting piece at fixed points to form an opening angle, and the opening angle is 0-80 degrees. That is to say, when the protective cover or protective shell of the mobile terminal is used, the connecting piece can movably unfold the main splint 10 and the auxiliary splint 11, that is, the main splint 10 and the auxiliary splint 1 of the protective case can be opened or closed to protect the mobile terminal. There are two connecting pieces, namely the first one is the first connecting piece 8 and the second one is the second connecting piece 7. Both ends of the rotating shaft connecting seat 1 can be connected to the auxiliary rotating flap mechanism through the first connecting piece 8 and the second connecting piece 7. The connecting piece is configured to be a rotating head with two parts: an inner end and an outer end. The inner end is inserted into the main mounting hole 101 at the end of the rotating shaft connecting seat 1, and the outer end is inserted into the auxiliary mounting hole at the end of the rotating pillar. The auxiliary mounting hole is the first mounting hole 301 or the second mounting hole 501. The auxiliary mounting hole is configured to penetrate through the end of the first rotating pillar 3 or the second rotating pillar 5. A sealing plug 9 is provided at the position of the auxiliary mounting hole at the outer end of the first rotating pillar 3 to block the mounting hole at the outer end of the rotating pillar, so to play a decorative role on the first rotating pillar 3 or the second rotating pillar 5, and increase the overall aesthetics of the protective case rotating shaft. The rotating head is configured to pivot the main rotating flap mechanism and the auxiliary rotating flap mechanism into one piece. The lateral length of the outer end of the rotating head does not exceed the lateral length of the inner end, so that the lateral length of the right post 84 can be set to be no more than the lateral length of the left post 86, so that the left post 86 can be extended into the main mounting hole 101 more, the connection stability between the rotating shaft connecting seat 1 and the left pin 86 is improved.

The main rotating flap mechanism, the auxiliary rotating flap mechanism and the connecting piece can all be elastic plastic, metal, or wood material structures, such as plastic, rubber plate, plywood, aluminum plate, and alloy plate are also suitable for the embodiments of the present application, and the main connecting piece 2, the first connecting plate 4 and the second connecting plate 6 can be arranged in a sheet-like structure to improve their elastic deformation ability.

It should be added that the protective case rotating shaft disclosed in this application is not only applied to the mobile terminal protective case or protective shell, but also can be applied to some opening and closing doors and windows. For other two parts such as reversible parts, the parts can be the protective cover of the device, and the protective cover is connected to the device through the protective case rotating shaft disclosed in this application, so that the protective cover can be opened or closed on the device.

### Embodiment 2

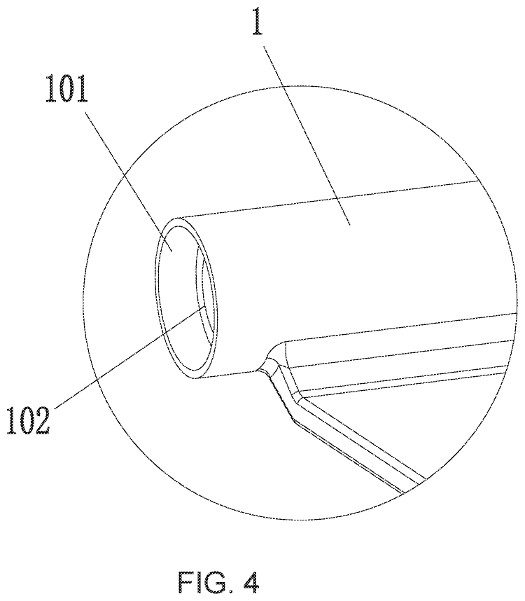

Please refer to FIGS. 4, 6, 7, 8 and 9, the inner end is a left post 86 extending into the main mounting hole 101, and a platform is provided in the cavity of the main mounting hole 101. Concave and convex parts are distributed on the outer surface of the inner end; The concave-convex part is used to increase the connection stability between the rotating head and the rotating shaft connecting seat 1, and the concave-convex part comprises a convex part connected to the left post 86 and a concave part arranged on the outer wall of the convex part. The cross-sectional shape of the platform is configured to be the shape of a ring, the platform is provided with a circular hole into which the left post 86 extends, and the platform is configured to support the convex part, and the convex part is closely attached to the hole wall of the main mounting hole 101.

The platform mentioned above is the main supporting table 102 arranged on the inner wall of the main mounting hole 101, and the platform mentioned above is also provided on the inner wall of the auxiliary mounting hole, that is, the inner wall platform of the auxiliary mounting hole is the auxiliary supporting table 302. The main supporting table 102 can limit the positioning of the left post 86, so that the left post 86 can be more stably extended into the main 1 mounting hole 101, so that the rotating head can be firmly connected to the shaft connecting seat 1.

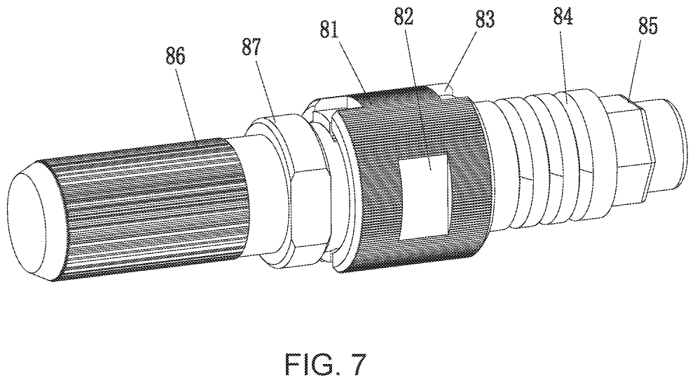

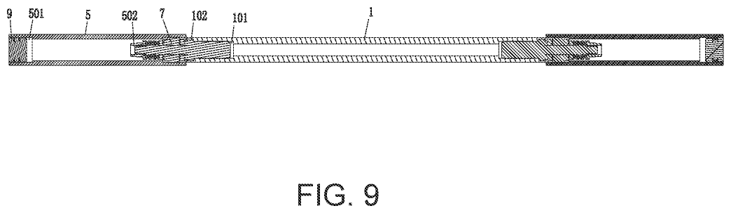

Please refer to FIG. 7 and FIG. 9, the mentioned convex part comprises a fixed wheel 81 and a positioning ring 87 which are sequentially fixed and sleeved on the left post 86, the fixed wheel 81 is located at the end of the left post 86, and the diameter of the wheel body of the fixed wheel 81 is equal to the inner diameter of the main mounting hole 101. The fixed wheel 81 is configured to limit the opening angle between the main rotating flap mechanism and the auxiliary rotating flap mechanism to 0 degrees or 20-70 degrees. The concave part comprises a notch 83 provided on the side wall of the fixed wheel 81 and a groove 82 opened on the side wall of the fixed wheel 81, and at least two grooves 82 are provided. Tooth-like patterns for increasing the surface roughness are distributed on the outer wall of the fixed wheel 81 and the left post 86 at intervals, and the tooth-like patterns on the left post 86 is closely attached to the hole wall of the circular hole inside the platform. Relying on the tooth-like patterns, the roughness and friction of the surface of the left post 86 can be improved, so that the cylindrical surface of the left post 86 has more grip, so that the left post 86 is more firmly and stably connected to the main mounting hole 101 of the rotating shaft connecting seat 1. The ring outer diameter of the mentioned positioning ring 87 is equal to the inner diameter of the main mounting hole 101. When the inner end is combined with the rotating shaft connecting seat 1 of the main rotating flap mechanism, the left post 86 and the positioning ring 87 together extend into the main mounting hole 101 of the rotating shaft connecting seat 1. The positioning ring 87 is, but not limited to, a nut. The positioning ring 87 is welded on the outer wall of the left post 86, and the positioning ring 87 is adjacent to the left side wall of the fixed wheel 81. The side view shape of the inner hole of the main mounting hole 101 is the same as the side view shape of the positioning ring 87, so that the outer wall of the positioning ring 87 can be closely attached to the inner hole wall of the main mounting hole 101, so that the left post 86 is firmly installed on the rotating shaft connecting seat 1. The outer end is a right post 84 extending into the auxiliary mounting hole, and the right post 84 extends into the auxiliary mounting hole. A boss 85 is integrally connected to the end of the right post 84, and a concave position for inserting the boss 85 is provided in the auxiliary mounting hole. The concave position is a socket 502 arranged in the first mounting hole 301 or the second mounting hole 501. Through the cooperation between the boss 85 and the socket 502, the structural stability of the right post 84 installed in the first mounting hole 301 or the second mounting hole 501 can be improved.

It should be noted that the above-mentioned outer end and inner end are integrally connected and formed, that is, the left post 86 and the right post 84 are joined together by means of integral connection and formation. The mentioned right post 84 is but is not limited to a pin, the pin is used to control the opening angle of the auxiliary connecting part, and the pin is connected with the fixed wheel 81 as a whole and extends into the auxiliary mounting hole of the auxiliary rotating flap mechanism together, that is, the right post 84 and the fixed wheel 81 extend into the auxiliary mounting hole together, that is, the right post 84 is extended into the first mounting hole 301 or the second mounting hole 501, and the diameter of the wheel body of the fixed wheel 81 is the same as that of the inner hole of the auxiliary mounting hole. The right post 84 extends into the auxiliary mounting hole together with the boss 85. The inner hole of the auxiliary mounting hole has a three-section hole diameter, the diameter of the inner section, that is, the diameter of the concave position is equal to the width of the boss 85, the diameter of the middle section is equal to the cylinder diameter of the right post 84, and the diameter of the outer section is the same as the diameter of the wheel body of the fixed wheel 81, so as to realize the movable connection between the main rotating flap mechanism and the auxiliary rotating flap mechanism through the inner end and the outer end.

The tooth-like patterns, the notches 83 and the grooves 82 on the upper surface of the fixed wheel 81 can improve the friction force on the surface of the fixed wheel 81, enhance the gripping force of the surface of the fixed wheel 81, and make the surface of the fixed wheel 81 have a damping function. Thus, the fixed wheel 81 is configured to be a damping wheel, so that the rotating flap mechanism can rotate 0-80 degrees around the fixed point of the rotating head. Within the rotation angle range of 0-80 degrees, the opening angle between the main rotating flap mechanism and the auxiliary rotating flap mechanism can be adjusted according to the needs of its rotating flap mechanism. When the opening angle between the main rotating flap mechanism and the auxiliary rotating flap mechanism is selected as 30 degrees, 45 degrees or 60 degrees, mobile terminals such as tablet computer or laptops can be placed on one of the main rotating flap mechanism and the auxiliary rotating flap mechanism. Therefore, it is used as a mobile terminal support frame, and the mobile terminal is placed on the unfolded rotating flap mechanism, thereby improving the convenient use function of the mobile terminal.

### Embodiment 3

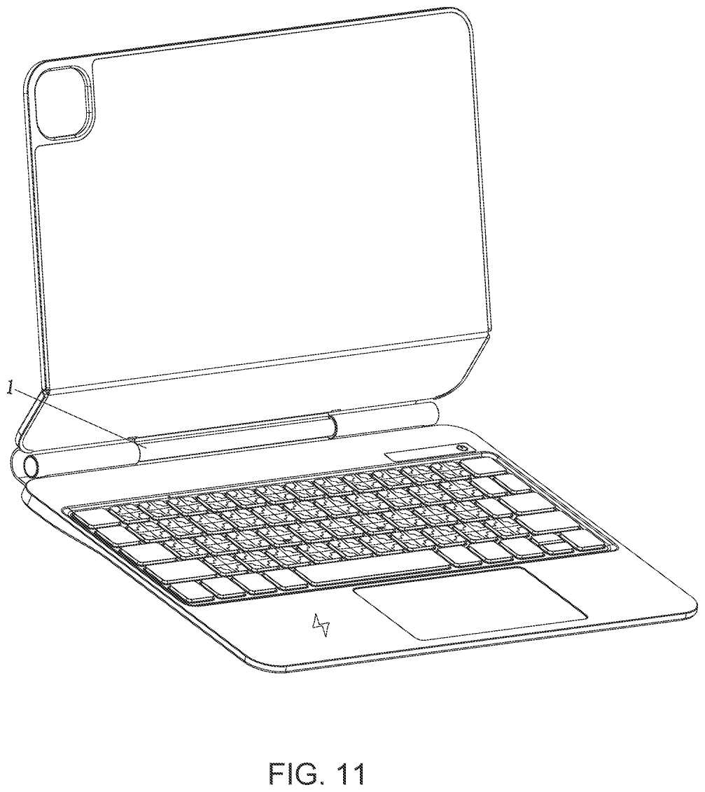

Referring to FIG. 11, in combination with the contents of Embodiment 1 and Embodiment 2, the present application provides a protective case rotating shaft according another embodiment, which is applied to a keyboard protective cover or protective shell of a mobile terminal. The main connecting plate 2 of the main rotating flap mechanism is detachably connected to the main splint 10 at the bottom of the keyboard cover, and the first connecting plate 4 or the second connecting plate 6 of the auxiliary rotating flap mechanism on both sides is detachably connected to the auxiliary splint 11 at the top of the keyboard cover. The auxiliary splint 11 is configured to be a two-section structure, and the two parts of the auxiliary splint 11 are connected together by a hinge with a damping function. The lower part of the auxiliary splint 11 is connected with the auxiliary rotating flap mechanism, and the upper part of the auxiliary splint 11 can be bent along the hinge. The bending angle between the upper part and the lower part of the auxiliary splint 11 is 10-50 degrees. That is to say, during use, the auxiliary splint 1 of the keyboard cover rotates to 30 degrees or 45 degrees or 60 degrees along the rotating head, that is, the angle between the auxiliary splint 11 and the main splint 10 is 30 degrees or 45 degrees or 60 degrees, and the upper part of the auxiliary splint 11 is bent to 60-70 degrees along the hinge, so that mobile terminals such as tablet and notebook computer can be placed on the upper part of the auxiliary splint 11. A use angle of 110-120 degrees is formed between the mobile terminal and the keyboard on the main splint 10, so that the keyboard cover is used as a facility with the same function as the mobile phone bracket, which assists the convenient use of the mobile terminal.

It should be noted that, when the protective case rotating shaft is applied to the keyboard protective cover or protective shell of the mobile terminal, the assembly of the protective case rotating shaft needs to be completed in advance, and the assembly steps of the protective case rotating shaft are as follows: Take the installation of the first auxiliary rotor mechanism at one end of the main rotor mechanism as an example; first install the main connecting plate 2 on the central axis of the outer wall of the rotating shaft connecting seat 1, and then extend the left post 86 into the hole cavity of the main mounting hole 101. The positioning ring 87 extends into the main mounting hole 101, and the positioning ring 87 is attached to the main supporting table 102; then the first rotating pillar 3 is placed laterally, and the first connecting plate 4 is arranged on the central axis of the outer wall of the first rotating pillar 3, and the right plug 84 is inserted into the first mounting hole 301 on the cylinder of the first rotating pillar 3, and the fixed wheel 81 is inserted into the first mounting hole 301 accordingly. When the rotating shaft connecting seat 1 is connected with the first rotating pillar 3, the main connecting plate 2 and the first connecting plate 4 are in a state of being parallel to each other; When the fixed wheel 81 is completely placed in the cavity of the first mounting hole 301, a section of the end of the rotating shaft connecting seat 1 also extends into the first mounting hole 301. The length of the end of the rotating shaft connecting seat 1 extending into the first mounting hole 301 is equal to the distance between the positioning ring 87 and the fixing wheel 81. Finally, a sealing plug 9 is inserted into the first mounting hole 301 at the free surface of the end of the first rotating pillar 3, and the sealing plug 9 has a decorative effect on the first rotating pillar 3, so as to allow the protective case rotating shaft is more beautiful. The same steps as above, add a second auxiliary rotating flap mechanism on the other end of the main rotating flap mechanism. The protective case rotating shaft disclosed in the present application is easy to assemble, has a wide range of use, and has various functions. It can be applied to the movable connection of two parts on mobile terminal equipment, and can be used as a mobile bracket for electronic equipment, and is used in the fields of mobile phone brackets, mobile terminal brackets, electronic device protective covers, and tablet protective covers. At the same time, it can control the protective clip at 0 degrees and 30 degrees, 45 degrees or 60 degrees to open and close, so that the protective case rotating shaft will not be squeezed and worn on the mobile terminal due to excessive clamping, and the protective case rotating shaft will not be damaged due to excessive expansion. This greatly prolongs the service life of the protective case and improves the overall durability of the protective case rotating shaft.

The overall shapes of the rotating shaft connecting seat 1 and the rotating pillar are all cylindrical structures. The diameter of the seat body at the end of the rotating shaft connecting seat 1 is equal to the inner hole diameter of the auxiliary mounting hole of the rotating pillar. The end of the rotating shaft connecting seat 1 can extend into the auxiliary mounting hole, that is, the end of the rotating shaft connecting seat 1 extends into the first mounting hole 301 or the second mounting hole 501, so that the rotating head can connect the rotating shaft connecting seat 1 to the second mounting hole 501. Therefore, the rotating head firmly integrates the rotating shaft connecting seat 1 and the rotating column into one piece, so as to form a protective case rotating shaft with stable structure.

It should be noted that, through the fixed wheel 81, the auxiliary rotating flap mechanism can be rotated around the rotating head to perform the unfolding and closing operations between four positions of 0, 30, 45 or 60 degrees. Since the surface of the fixed wheel 81 is provided with tooth-like patterns, the fixed wheel 81 is stably installed in the first mounting hole 301 or the second mounting hole 501. The outer wall of the fixed wheel 81 is provided with four groups of notches 83 and grooves 82 distributed symmetrically in the center, and the grooves 82 are arranged between adjacent notches 83. When the auxiliary rotating flap mechanism rotates around the rotating head, the first rotating pillar 3 or the second rotating pillar 5 rotates around the fixed wheel 81. Due to the notch 83 and the groove 82, the four gears formed on the surface of the fixed wheel 81 make the first rotating pillar 3 or the second rotating pillar rotates 0 degrees, 30 degrees, 45 degrees or 60 degrees counterclockwise around the fixed wheel 81, or rotates 60 degrees, 45 degrees, 30 degrees or 0 degrees clockwise around the fixed wheel 81, and then let the auxiliary rotating mechanism rotate around the rotating head to perform the unfolding and closing operation between the four gears of 0 degrees, 30 degrees, 45 degrees or 60 degrees.

It is added that when the protective case rotating shaft disclosed in this application is used, one or more can be selectively connected in series on the rotating shaft connecting seat 1 according to the needs of use, for example, when it is applied to the movable connection of two parts. The auxiliary rotating flap mechanism is suitable for the movable connection of doors and windows, that is, the movable connection between the window door and the window frame, and the movable connection between the door and the door frame, so it will not be repeated here.

The technical features of the above embodiments can be combined arbitrarily. For the sake of brevity, all possible combinations of the technical features in the above embodiments are not described. The technical features of the above embodiments can be combined arbitrarily. For the sake of brevity, all possible combinations of the technical features in the above embodiments are not described.

The above embodiments only represent the preferred embodiments of the present application, and the descriptions thereof are more specific and detailed, but should not be construed as a limitation on the scope of the present application; It should be pointed out that for those of ordinary skill in the art, without departing from the concept of the present application, several modifications and improvements can be made, which all belong to the protection scope of the present application; In the present application, unless otherwise expressly specified and limited, the terms “installation”, “connection”, “fixation” and other terms should be understood in a broad sense, for example, it may be a fixed connection or a detachable connection, or formed as one; It can be a mechanical connection; it can be a direct connection, or an indirect connection through an intermediate medium, and it can be the internal communication of two components or the interaction relationship between the two components; there are many ways of detachable installation, for example, it can be matched by plugging and snap-fit, and for example, it can be connected by bolts. Therefore, any modification, equivalent replacement, improvement, etc., made to the above embodiments based on the actual technology of the present application still fall within the scope of the technical solution of the present application.

What is claimed is:

1. A protective case rotating shaft, comprising a main rotating flap mechanism and auxiliary rotating flap mechanisms arranged at both sides of the main rotating flap mechanism, the auxiliary rotating flap mechanism is configured to connect with the main rotating flap mechanism through a connecting piece, and the main rotating flap mechanism is composed of a rotating shaft connecting seat and a main connecting part connected to the rotating shaft connecting seat, the auxiliary rotating flap mechanism is composed of a rotating pillar and an auxiliary connecting part connected to the rotating pillar, the connecting piece is configured to connect the main rotating flap mechanism with the auxiliary rotating flap mechanism together, so that the main rotating flap and the auxiliary rotating flap mechanism move around the connecting piece at fixed points to form an opening angle, and the opening angle is 0-80 degrees,
the connecting piece is configured to be a rotating head with two parts: an inner end and an outer end, the inner end is configured to be inserted into a main mounting hole at the end of the rotating shaft connecting seat, and the outer end is configured to be inserted into an auxiliary mounting hole at the end of the rotating pillar.

2. The protective case rotating shaft according to claim 1, wherein the rotating head is configured to pivot the main rotating flap mechanism and the auxiliary rotating flap mechanism into one piece and the lateral length of the outer end of the rotating head does not exceed the lateral length of the inner end.

3. The protective case rotating shaft according to claim 1, wherein the inner end is a left post extending into the main mounting hole, a platform is arranged in the cavity of the main mounting hole, and the outer surface of the inner end is provided with concave-convex parts; the concave-convex parts are configured to increase the connection stability between the rotating head and the rotating shaft connecting seat, and the concave-convex parts comprise convex parts connected to the left post and concave parts arranged on the outer wall of the convex parts.

4. The protective case rotating shaft according to claim 3, wherein the cross-sectional shape of the platform is configured to be the shape of a ring, the platform is provided with a circular hole into which the left post extends, and the platform is configured to support the convex part, and the convex part is closely attached to the hole wall of the main mounting hole.

5. The protective case rotating shaft according to claim 1, wherein the convex part comprises a fixed wheel and a positioning ring that are sequentially fixed and sleeved on the left post, the fixed wheel is located at the end of the left post, and the diameter of the wheel body of the fixed wheel is equal to the inner hole diameter of the main mounting hole, and the fixed wheel is configured to limit the opening angle between the main rotating flap mechanism and the auxiliary rotating flap mechanism to 0 degrees or 20-70 degrees, the concave part comprises a notch provided on the side wall of the fixed wheel and a groove opened on the side wall of the fixed wheel, and at least two grooves are provided.

6. The protective case rotating shaft according to claim 5, wherein tooth-like patterns for increasing the surface roughness are distributed on the outer wall of the fixed wheel and the left post at intervals, and the tooth-like patterns on the left post is closely attached to the hole wall of the circular hole inside the platform.

7. The protective case rotating shaft according to claim 1, wherein the outer end is configured to be a right insertion post inserted into the auxiliary mounting hole, and the right insertion post is inserted into the auxiliary mounting hole.

8. The protective case rotating shaft according to claim 7, wherein a boss is integrally connected to the end of the right insertion post, and a concave position for the boss to be inserted is provided in the auxiliary mounting hole.

9. The protective case rotating shaft according to claim 1, wherein the main connecting part and the auxiliary connecting part are both provided with through holes, and the auxiliary connecting part is vertically connected on a central axis of the outer wall of the rotating pillar, and the main connecting portion is vertically connected on a central axis of the outer wall of the rotating shaft connecting seat.

10. The protective case rotating shaft according to claim 1, wherein the lateral length of the rotating pillar does not exceed the lateral length of the rotating shaft connecting seat, and the outer surfaces of the ends of the rotating pillar and the rotating shaft connecting seat are both provided with a frosted layer.
